(19) United States
(12) Patent Application Publication
(10) Pub. No.: US 2015/0066649 A1
(43) Pub. Date: Mar. 5, 2015

(54) SYSTEM AND METHOD OF PROVIDING TOURISTIC PATHS

(71) Applicants: Sanjiv Kumar, Brooklyn, NY (US); Jason Weston, New York, NY (US)

(72) Inventors: Sanjiv Kumar, Brooklyn, NY (US); Jason Weston, New York, NY (US)

(73) Assignee: Google Inc., Mountain View, CA (US)

(21) Appl. No.: 12/768,101

(22) Filed: Apr. 27, 2010

(51) Int. Cl. G01C 21/00; G06Q 30/00

(52) U.S. Cl. 705/14.64; 705/14.49

(57) ABSTRACT

Systems and methods provide touristic routes to users. For example, a user at a client device may request a touristic route between an initial and a final destination. A server uses the initial and final destinations to determine a shortest route. The server then defines an envelope around the route in order to identify points of interest. The identified points of interest are ranked and filtered, in order to select the most relevant points of interest. Once the points of interest are selected, the server determines a final route between the initial destination, the points of interest, and the final route. This information is then transmitted to the client device and displayed to the user. The server may also identify and transmit content associated with the final route and/or the points of interest, including, but not limited to, photos, videos, hyperlinks, and advertisements.

### BACKGROUND OF THE INVENTION

Various navigation systems provide users with turn-by-turn directions. These systems include handheld GPS devices or mobile phones, vehicle-mounted devices, or Internet-based computers with access to applications such as Google Maps. Users input one or more locations and receive a route and turn-by-turn directions. Generally, these systems generate turn-by-turn directions based on static map data, for example, routing users along the biggest roadways or roads with the highest speed limits. These systems may select the fastest route based on the shortest estimated time to travel along the route. The user may follow the turn-by-turn directions to reach the one or more locations.

Other systems, such as Google's City Tour, provide users with walking tours around a city. For example, the user provides the name of a city or an address and the amount of time that the user would like to spend there. In response these systems provide the user with a suggested walking tour around the location.

### BRIEF SUMMARY OF THE INVENTION

The present invention relates generally to providing a route between two locations which identifies one or more points of interest. More specifically, the invention relates to providing identifying relevant points of interest based, in part, on the shortest distance between the two locations.

One aspect of the invention provides a method of providing a touristic route for display on a display apparatus of a first computer. The method includes receiving, from the first computer, a request for a touristic route including a location set including an initial destination and a final destination; determining, by a second computer, a shortest route between the locations of the location set; determining an envelope which describes a geographic area proximate to the shortest route; accessing a plurality of points of interest, each point of interest of the plurality being associated with a geographic location; identifying a first set of points of interest from the plurality of points of interest based on the geographic area of the envelope and the geographic location associated with each point of interest of the plurality; ranking the first set of points of interest based on ranking criterion; identifying a maximum number of points of interest to be selected; selecting points of interest based on the maximum number and the rankings; determining a final touristic route based on the locations of the location set and the selected points of interest; and transmitting, to the first computer, the final touristic route for display on the display apparatus.

In one example, the initial destination and the final destination correspond to the same geographic location. In another example, the request for a touristic location includes a time period, and the envelope is determined based on the time period. In another example, the request for a touristic location includes a maximum deviation from the shortest route, and the envelope is determined based on the maximum deviation. In another example, the method also includes accessing a default deviation value, and wherein the envelope is determined based on the default deviation value. In another example, each point of interest of the plurality is associated with a category, and the request for a touristic location includes an identification of a category, the method further comprising filtering the first set of points of interest based on the identification of the category. In another example, the ranking criterion includes the average number of tourists visiting a point of interest yearly. In another example, the ranking criterion includes at least one user review of a given one of the plurality of points of interest. In another example, the method also includes identifying content associated with a particular selected point of interest and transmitting the identified content to the first computer. In one alternative, the identified content includes an advertisement. In another alternative, the identified content includes video. In another example, the identified content includes a hyperlink to a network location. In another example, the method also includes identifying content associated with the final touristic route and transmitting the identified content to the first computer. In another example, the maximum number of points of interest to be selected is identified in the request for a touristic route. In another example, the maximum number of points of interest is a default value accessible by the second computer. In another example, the first computer is a mobile device.

Another aspect of the invention provides a device for providing a touristic route for display on a display apparatus of a computer. The device includes electronic memory accessible by the device and a processor. The processor is programmed to receive, from the computer, a request for a touristic route including a location set including an initial destination and a final destination; determine a shortest route between the locations of the location set; determine an envelope which describes a geographic area proximate to the shortest route; access a plurality of points of interest, each point of interest of the plurality being associated with a geographic location; identify a first set of points of interest from the plurality of points of interest based on the geographic area of the envelope and the geographic location associated with each point of interest of the plurality; rank the first set of points of interest based on ranking criterion; identify a maximum number of points of interest to be selected; select points of interest based on the maximum number and the rakings; determine a final touristic route based on the locations of the location set and the selected points of interest; and transmit, to the computer, the final touristic route for display on the display apparatus.

In one example, the request for a touristic location includes a time period, and envelope is determined based on the time period. In another example, the request for a touristic location includes a maximum deviation from the shortest route, and the envelope is determined based on the maximum deviation. In another example, each point of interest of the plurality is associated with a category, and the request for a touristic location includes an identification of a category, the processor of the device further programmed to filter the first set of points of interest based on the identification of the category. In another example, the request for a touristic route also includes information to identify a category of route and the processor is further programmed to determine the final touristic route based on the category of route. In one alternative, the category of route is a driving route.

### BRIEF DESCRIPTION OF THE DRAWINGS

FIG. 1A is a functional diagram of a system in accordance with an aspect of the invention.

FIG. 1B is a pictorial diagram of a system in accordance with an aspect of the invention.

FIG. 2 is a diagram in accordance with an aspect of the invention.

FIG. 3 is a diagram in accordance with an aspect of the invention.

FIG. 4 is a diagram in accordance with an aspect of the invention.

FIG. 5 is a diagram in accordance with an aspect of the invention.

FIG. 6 is a diagram in accordance with an aspect of the invention.

FIG. 7 is a screen shot in accordance with an aspect of the invention.

FIG. 8 is a screen shot in accordance with an aspect of the invention.

FIG. 9 is a client device in accordance with an aspect of the invention.

FIG. 10 is a client device in accordance with an aspect of the invention.

FIGS. 11A and 11B are a flow diagram in accordance with an aspect of the invention.

### DETAILED DESCRIPTION

Aspects, features and advantages of the invention will be appreciated when considered with reference to the following description of exemplary embodiments and accompanying figures. The same reference numbers in different drawings may identify the same or similar elements. Furthermore, the following description is not limiting; the scope of the invention is defined by the appended claims and equivalents.

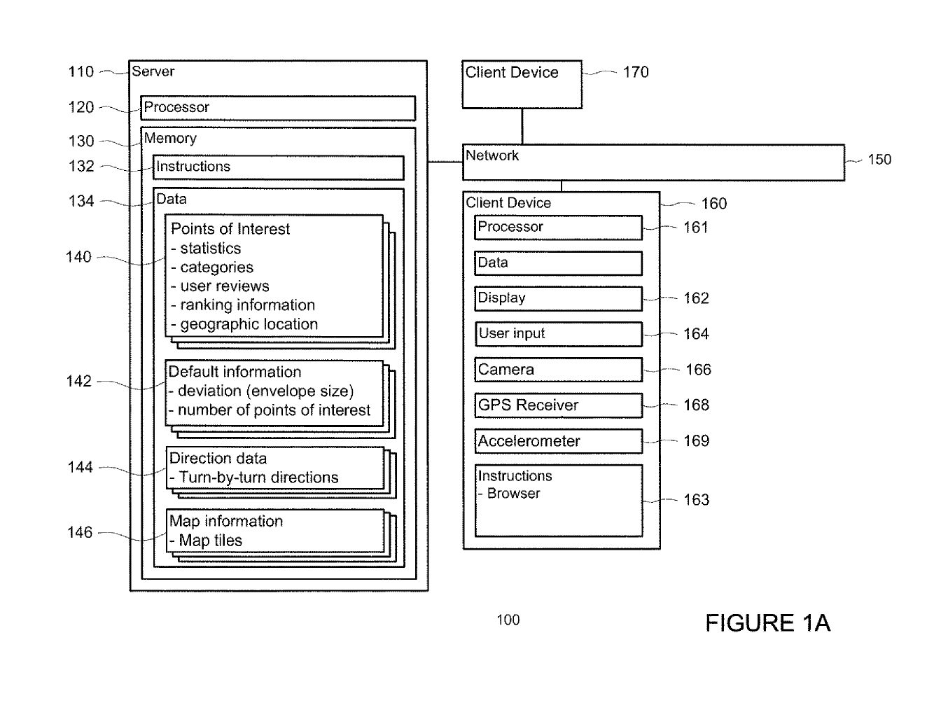

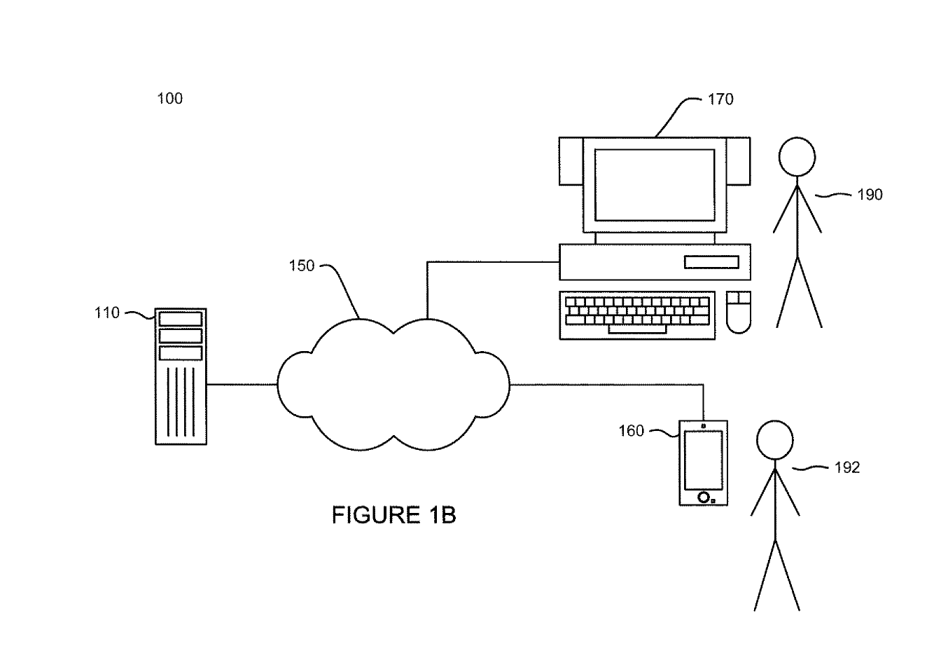

As shown in FIGS. 1A-B, a system 100 in accordance with one aspect of the invention includes a computer 110 containing a processor 120, memory 130 and other components typically present in general purpose computers.

The memory 130 stores information accessible by processor 120, including instructions 132 and data 134 that may be executed or otherwise used by the processor 120. The memory 130 may be of any type capable of storing information accessible by the processor, including a computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. For instance, although the system and method is not limited by any particular data structure, the data may be stored in computer registers, in a relational database as a table having a plurality of different fields and records, XML documents or flat files. The data may also be formatted in any computer-readable format. By further way of example only, image data may be stored as bitmaps comprised of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

The processor 120 may be any conventional processor, such as processors from Intel Corporation or Advanced Micro Devices. Alternatively, the processor may be a dedicated controller such as an ASIC. Although FIG. 1A functionally illustrates the processor and memory as being within the same block, it will be understood by those of ordinary skill in the art that the processor and memory may actually comprise multiple processors and memories that may or may not be stored within the same physical housing. For example, memory may be a hard drive or other storage media located in a server farm of a data center. Accordingly, references to a processor or computer will be understood to include references to a collection of processors or computers or memories that may or may not operate in parallel.

The computer 110 may be at one node of a network 150 and capable of directly and indirectly communicating with other nodes of the network. For example, computer 110 may comprise a web server that is capable of communicating with client devices 160 and 170 via network 150 such that server 110 uses network 150 to transmit and display information to a user 190 on display 162 of client device 170. Server 110 may also comprise a plurality of computers that exchange information with different nodes of a network for the purpose of receiving, processing and transmitting data to the client devices. In this instance, the client devices will typically still be at different nodes of the network than any of the computers comprising server 110.

Network 150, and intervening nodes between server 110 and client devices, may comprise various configurations and use various protocols including the Internet, World Wide Web, intranets, virtual private networks, local Ethernet networks, private networks using communication protocols proprietary to one or more companies, cellular and wireless networks (e.g., WiFi), instant messaging, HTTP and SMTP, and various combinations of the foregoing. Although only a few computers are depicted in FIGS. 1A-B, it should be appreciated that a typical system can include a large number of connected computers.

Each client device may be configured similarly to the server 110, with a processor, memory and instructions. Each client device 160 or 170 may be a personal computer intended for use by a person 190 or 192, and have all of the components normally used in connection with a personal computer such as a central processing unit (CPU) 161, memory (e.g., RAM and internal hard drives) storing data and instructions 163 including a web browser, an electronic display 162 (e.g., a monitor having a screen, a small LCD touch-screen, a projector, a television, a computer printer or any other electrical device that is operable to display information), user input 164 (e.g., a mouse, keyboard, touch-screen or microphone), camera 166, speakers, a network interface device, and all of the components used for connecting these elements to one another.

The client devices may also include a geographic position component 168, such as circuits, to determine the geographic location and orientation of the device. For example, client device 170 may include a GPS receiver to determine the device's latitude, longitude and altitude position. In another example, the geographic position component may also comprise software for determining the position of the device based on other signals received at the client device 170, such as signals received at a cell phone's antenna from one or more cell phone towers if the client device is a cell phone. In still another example, geographic position component may detect all WiFi networks in the vicinity, measure the strength of the signal from those networks, and use a table of WiFi access point locations to triangulate the geographic position of the client device. It will be understood that any number of geographic positioning systems, alone or in combination, may be used.

Client devices may also include an accelerometer 169 or gyroscope to determine the direction in which the device is oriented. By way of example only, the device may determine its pitch, yaw or roll (or changes thereto) relative to the direction of gravity or a plane perpendicular thereto. In that regard, it will be understood that a client device's provision of location and orientation data as set forth herein may be provided automatically to the user, to the server, or both.

Although the client devices 160 and 170 may each comprise a full-sized personal computer, they may alternatively comprise mobile devices capable of wirelessly exchanging data with a server over a network such as the Internet. By way of example only, client device 160 may be a wireless-enabled PDA or a cellular phone capable of obtaining information via the Internet. The user may input information using a small keyboard, a keypad or a touch screen. Indeed, computers in accordance with the systems and methods described herein may comprise any device capable of processing instructions and transmitting data to and from humans and other computers including general purpose computers, and network computers lacking local storage capability

Although certain advantages are obtained when information is transmitted or received as noted above, aspects of the invention are not limited to any particular manner of transmission of information. For example, in some aspects, information may be sent via a medium such as an optical disk or portable drive. In other aspects, the information may be transmitted in a non-electronic format and manually entered into the system. Yet further, although some functions are indicated as taking place on a server and others on a client, various aspects of the system and method may be implemented by a single computer having a single processor.

Returning to FIG. 1A server 110 may have access to point of interest data 140. Points of interest (“POI”) may include various locations which may interest visitors. For example, POIs may include, but are not limited to, museums, libraries, sculptures, parks, restaurants, hotels, amusement or water parks, bodies of water, or other landmarks. POIs may be retrieved from any source including, for example, state or private tourism guides, online forums, or other sources. Each POI may be associated with various types of information, including the geographic location, statistics related to the POI such as the average number of visitors per year, user reviews, categories, and ranking information. As will be described in detail below, this information may be used to select appropriate POIs.

In addition to POIs, server 110 may also have access to default information which may be used to select appropriate POIs. For example, as will be described in greater detail blow, the default information may include various values such as the maximum deviation from a route at which a selected point of interest may be located. In another example, the default information may include a maximum or minimum number of POIs to be selected for a particular route.

The system may also include direction data 144 for generating turn-by-turn directions based on a plurality of route segments. Turn-by-turn directions may include text instructions, audio instructions, and maps. Each turn-by-turn direction and associated route segment may be further associated with one or more map tiles such that each turn-by-turn direction may be displayed with the one or more map tiles. It will be understood that turn-by-turn directions are not limited to instructions to make simple turns, for example, other directions may include continuing on a road, taking a particular exit, etc.

Server 110 may store map-related information 146, at least a portion of which may be transmitted to a client device. For example and as shown in FIG. 1A, the server may store map tiles, where each tile comprises a map image of a particular geographic area. A single tile may cover an entire region such as a state in relatively little detail and another tile may cover just a few streets in high detail. In that regard, a single geographic point may be associated with multiple tiles, and a tile may be selected for transmission based on the desired level of zoom. The map information is not limited to any particular format. For example, the images may comprise street maps, satellite images, or a combination of these, and may be stored as vectors (particularly with respect to street maps) or bitmaps (particularly with respect to satellite images).

The various map tiles are each associated with geographical locations, such that the server 110 and/or client device are capable of selecting, retrieving, transmitting, or displaying one or more tiles in response to receiving one or more geographical locations.

The system and method may process locations expressed in different ways, such as latitude/longitude positions, street addresses, street intersections, an x-y coordinate with respect to the edges of a map (such as a pixel position when a user clicks on a map), names of buildings and landmarks, and other information in other reference systems that is capable of identifying geographic locations (e.g., lot and block numbers on survey maps). Moreover, a location may define a range of the foregoing. The system and method may further translate locations from one reference system to another. For example, the client 170 may employ or access a geocoder to convert a location identified in accordance with one reference system (e.g., a street address such as “1600 Amphitheatre Parkway, Mountain View, Calif.”) into a location identified in accordance with another reference system (e.g., a latitude/longitude coordinate such as (37.423021°, −122.083939)). In that regard, it will be understood that exchanging or processing locations expressed in one reference system, such as street addresses, may also be received or processed in other reference systems as well.

In addition to the operations described below and illustrated in the figures, various operations in accordance with a variety of aspects of the invention will now be described. It should be understood that the following operations do not have to be performed in the precise order described below. Rather, various steps can be handled in reverse order or simultaneously.

A user may request a touristic route between two or more locations. For example, a user, such as user 190, may enter one or more locations into a client device. The client device may transmit a request for a touristic route over a network to a server. The request may include a location set. For example, the location set may include the identification of an initial location, entered by the user or determined by a position component of the client device, as well as a destination location and any number of intermediary locations. It will be understood that in some operations the initial location and destination location may correspond to the same geographic locations.

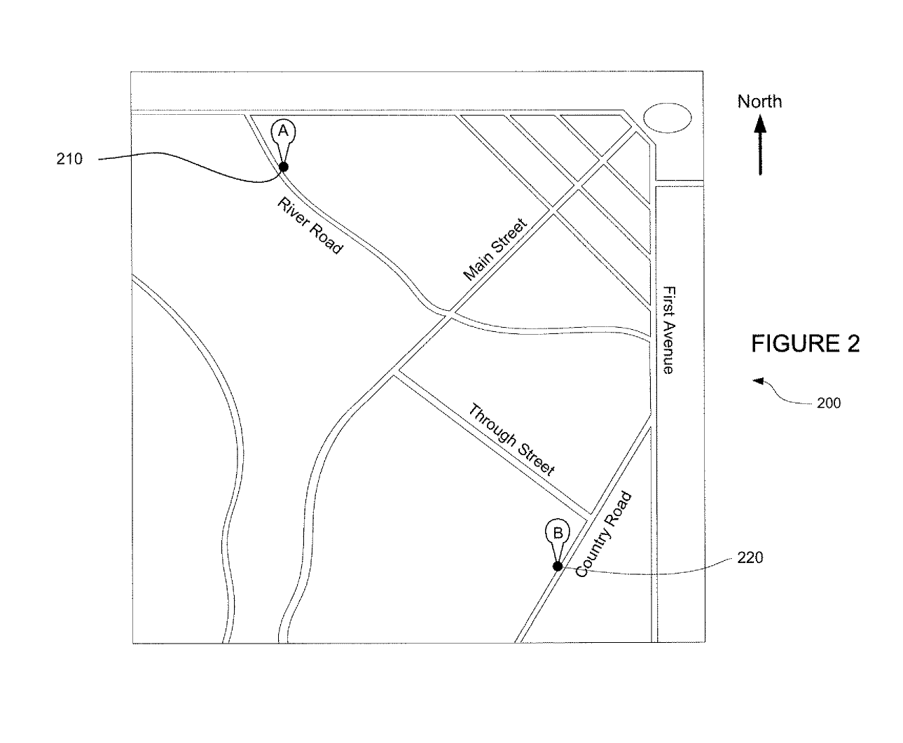

In the example of FIG. 2, a client device, such as client device 170, may transmit a location set including an initial destination and a final destination over a network 150 to server 110. For example, map 200 of FIG. 2 illustrates a location A, which corresponds to initial destination 210, may be located at 300 River Road. Location B, corresponding to final destination 220, may be located at 1510 Country Road.

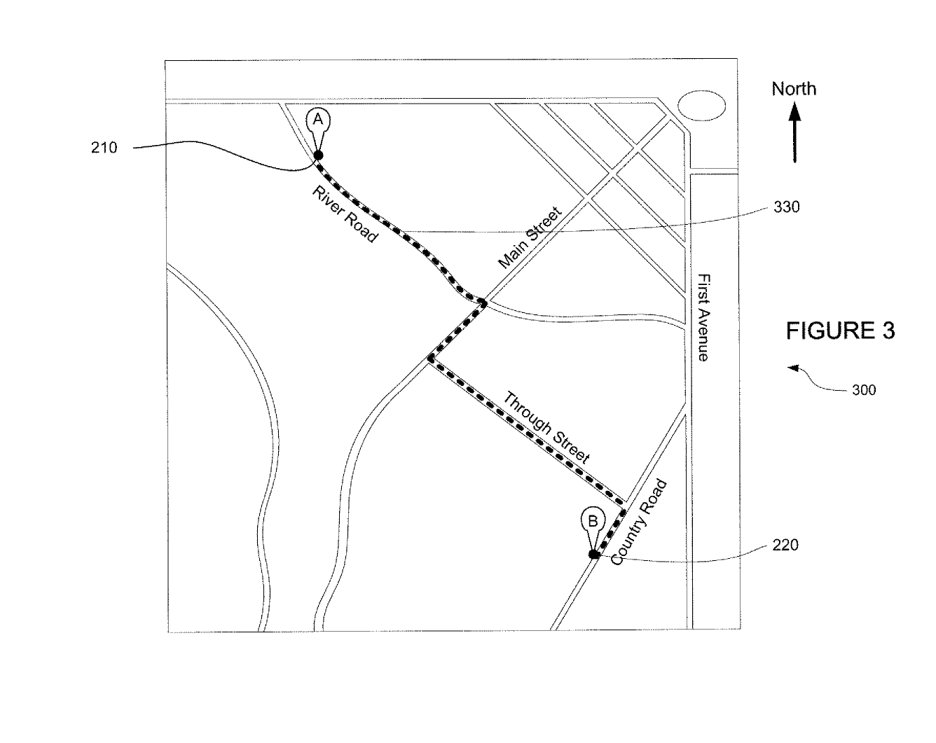

After receiving the destination set, the server may determine the shortest route between the locations of the location set. The shortest route may be defined in any number of ways, including for example, the shortest travel time or the shortest distance between the locations. For example, as shown on map 300 of FIG. 3, server 110 has determined the shortest route 330 between initial destination 210 and final destination 220.

Using the determined route, the server may identify a touristic envelope. The envelope may be defined as how far from the shortest route the user is willing to deviate in order to visit or pass by POIs. The deviation may be defined, for example, by any number of heuristics, including a distance, such as 20 miles, from the shortest route; a period of travel time, such as 20 additional minutes or 5 hours total time; a percentage of overall shortest route distance; or by taking the intersection of circular regions around chosen points along the path. As described above, the envelope may be defined by accessing a default value or identifying or receiving the value from client device 170. For example, user 190 may select from a list of preset values or enter a specific minimum or maximum value or range of values. Accordingly, a user may define specific parameters such as not more than 10% extra travel time, or not more than 10% extra travel distance.

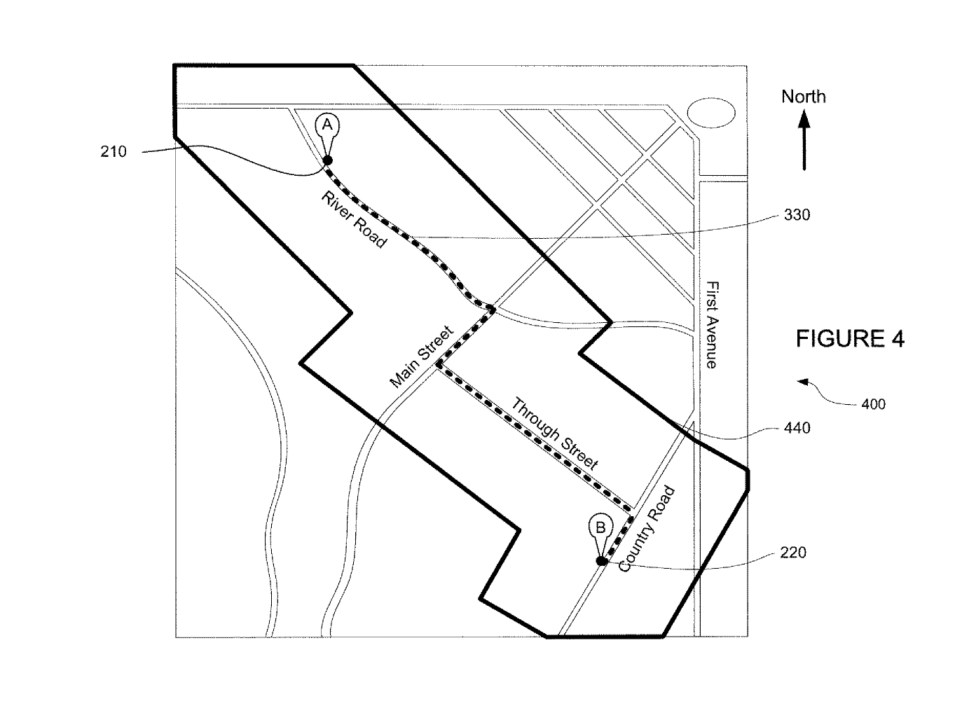

As shown in the example of FIG. 4, map 400 includes an exemplary envelope 440. In this example, server may have determined that the user would be willing to deviate no more than one mile from the route. Thus, envelope 440 is drawn approximately a half mile around shortest route 330.

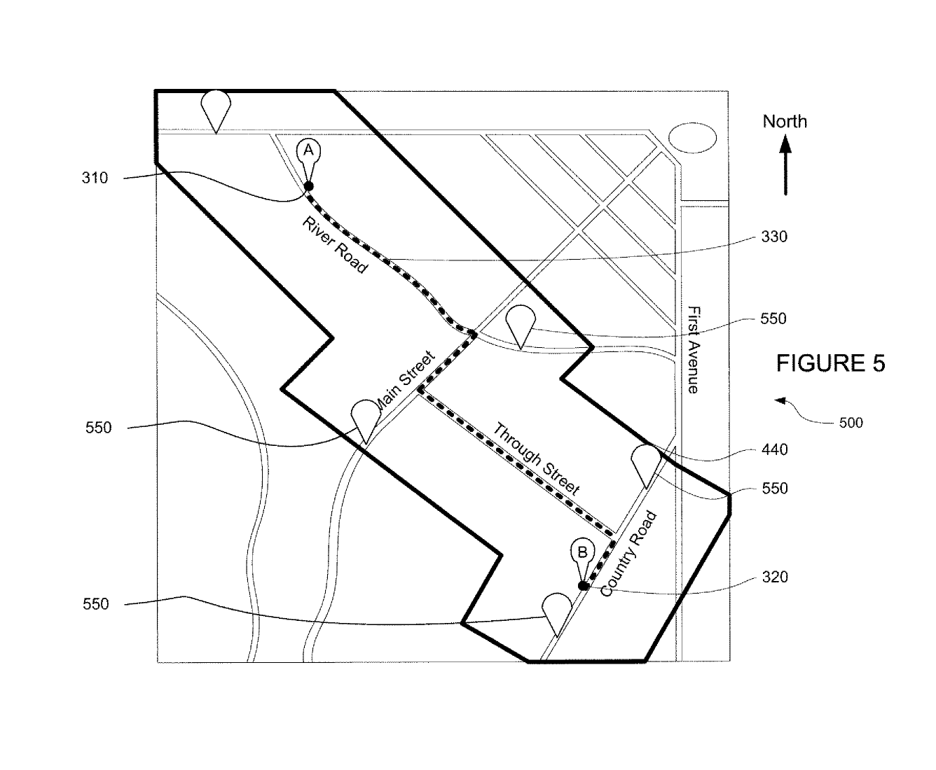

The envelope may be used to select POIs for the final touristic route. For example, as shown in FIG. 5, server 110 may determine that a plurality of POIs 550 are located within the envelope. As will be described below, the server may filter, by removing the filtered POI from the plurality of POIs or simply not considering the filtered POI, and rank these POIs in order to select the most relevant POIs for the final touristic route. It will be understood, that the ranking and filtering may be performed simultaneously by the server or in any order.

These POIs may be filtered by various methods, including categories. Categories may be preselected by the server or identified by a user and transmitted by a client device. For example, a user may select or request POIs related to museums, such that the selected POIs will correspond to locations such as parks, museums, or hotels. In another example, a user may provide additional information specific to the POI in which the user is interested. For example, a user may provide a request such as “‘Boston’ to ‘Florida,’ stopping at a ‘cheap motel.’”

In another example, a user may select a time frame or a specific date and time. Thus, the server may filter out locations which have operating hours which do not fit into the specified date and time data. If, for example, a POI, such as a garden, is open only during April through November from 9:00 am to 1:00 pm, and the user identifies a category corresponding to December at 12:00 pm, this POI may be filtered by removing the garden POI from the POIs within the envelope, or simply not considering the garden POI at all. Any number of categories may be selected, identified, and used. In addition, rather than using categories to merely filter the POIs, categories may be considered when ranking the POIs.

The server may use various considerations when ranking the POIs. For example, POIs may be ranked according to their perceived interestingness using any number of criteria. The server may use the average number of persons visiting a particular POI per year, user reviews, categories, the number of images of the POI uploaded by users on a public site, the numbers of user requesting information (for example searching) the POI, the number of users selecting (as described below) a particular POI to visit in previous requests for touristic paths, or any combination of these criteria.

Based on the rankings, the server may select the most relevant POIs. The number of POIs selected may be determined by selecting a default value, a value identified by the user, or determined by the server based on other input such as a maximum travel time identified by the user. Once the server has selected the POIs, server may generate a final touristic route based on the location set and the selected POIs. In one example, the POIs may be ordered based on the rankings described above. This information is then used to generate a set of turn-by-turn directions which may be transmitted by the server to the client device for display to the user.

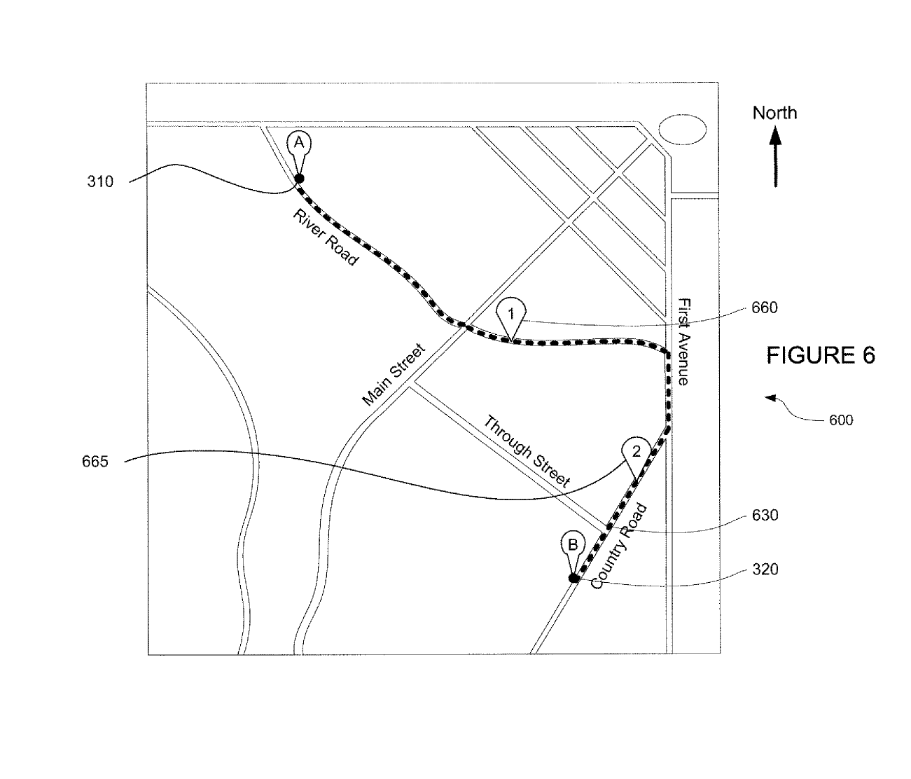

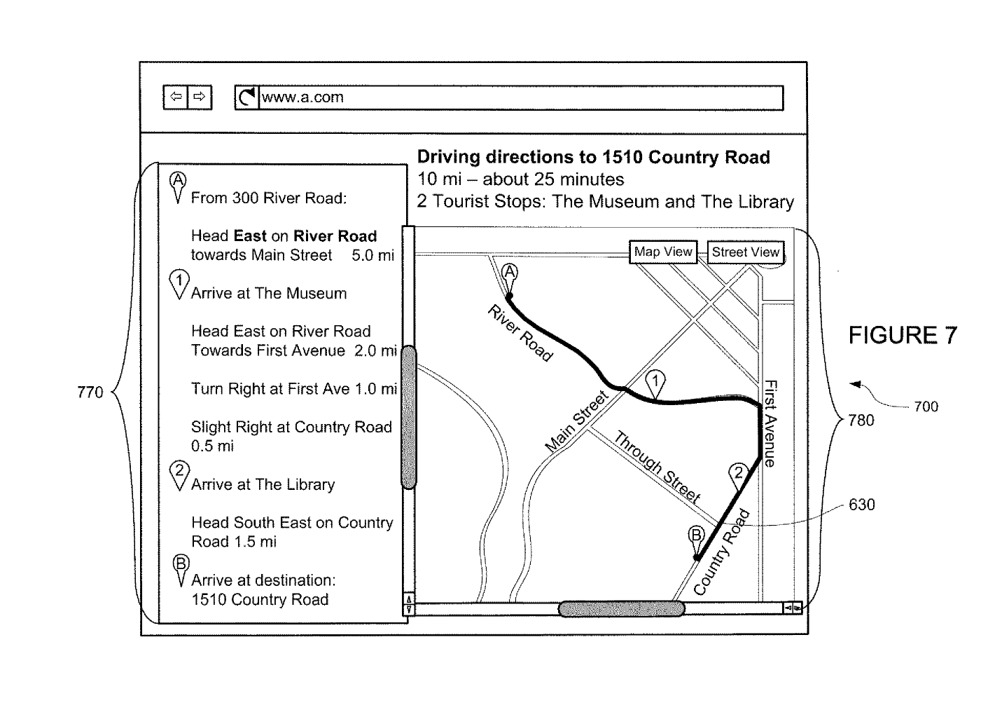

As shown on map 600 of FIG. 6, server 110 has selected two POIs, 660 and 665. Based on the locations of these POIs, the server has determined that route 630 is the shortest route between each of the locations. Server 110 transmits this information to client device 170 for display to user 190 as shown in exemplary screen shot 700 of FIG. 7. In the example of FIG. 7, server 110 may transmit, and client device 170 may display various types of information including turn-by-turn directions 770 as well as a map 780 identifying the final touristic route 630.

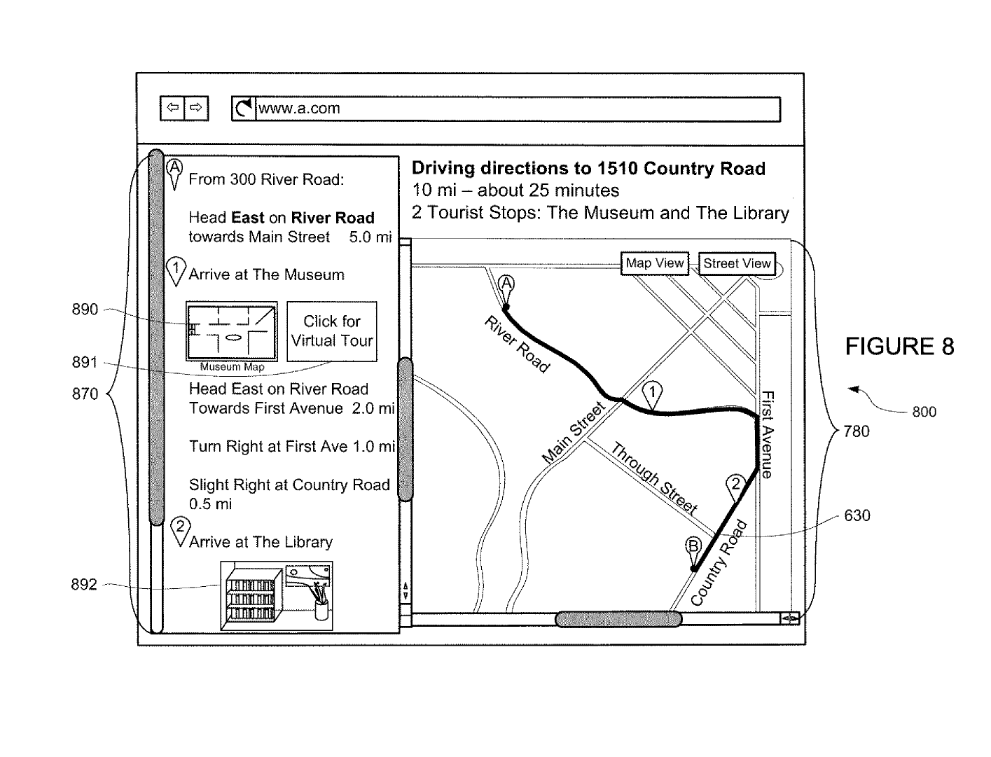

The server may also transmit additional content or hyperlinks to the client device to allow the user to view information related to the selected POIs. For example, the server may provide a visual summary of how the selected POIs may look, articles or images associated with the POI, short video clips generally focused on or related to the selected POIs, or video clips of the final touristic route. As will be understood, this additional content may be selected by any means, for example, including machine learning summarization techniques. As shown in exemplary screen shot 800 of FIG. 8, content 890-892 may be displayed with or proximate to turn-by-turn directions 870. In the example, the display includes content 890 which may be a map of the museum identified as POI 1, content 891 which may be a link to a virtual tour or video clip of the interior of the museum, as well as content 892 which may be an image of the interior of the library identified as POI 2.

The content provided by the server may include advertisements. In one example, the advertisement may be associated with a POI or the general location of the POI. For example, the server may provide advertisements associated with hotels, restaurants, and tourism-related marketing entities.

The server may also identify transmit for display content related to travel accommodations or reservations for the final touristic route. For example, taking into consideration the length of the trip, such as hours or days, the server may identify and display the most convenient or cheapest flights, hotels, car rentals, restaurants, etc.

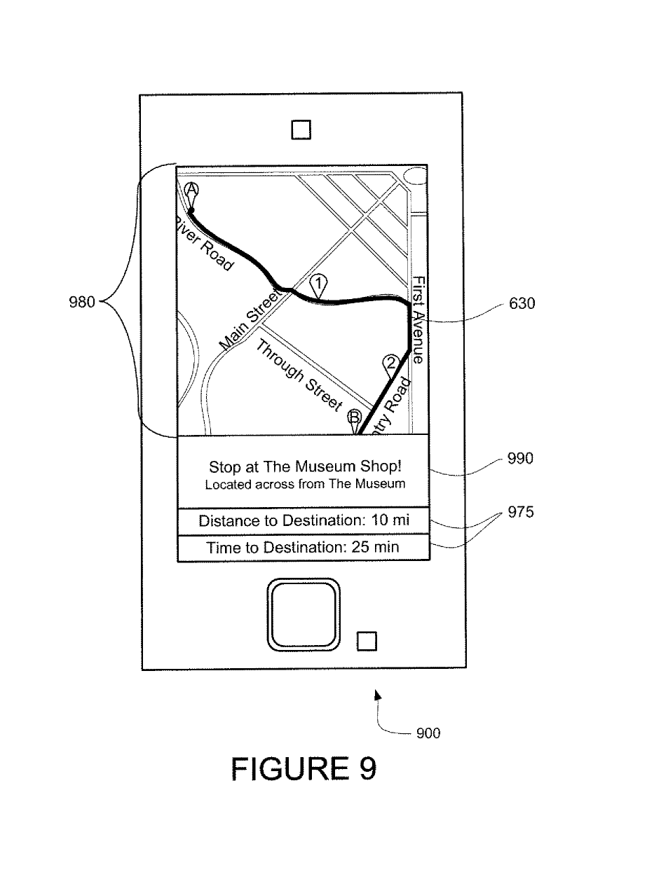

As shown in FIG. 9, a client device 900 may receive a map 980, the final touristic route 630, and an advertisement 990 from the server. The advertisement may be an image or may include one or more links to additional content such as a website. Advertisement may be identified by the server based on the POIs in which the user is interested, demonstrated, for example, by selecting these POIs as described below. Advertisements may also be selected based on the location of a particular POI. For example, the server may identify advertisements for hotels or restaurants located in the vicinity of the POI. Thus in some instances, a selected advertisements may not be directly related to a particular POI other than by geographic proximity of, for example, the business or context of the advertisement. The client device may also display travel information 975 such as the distance to the final destination and the total travel time.

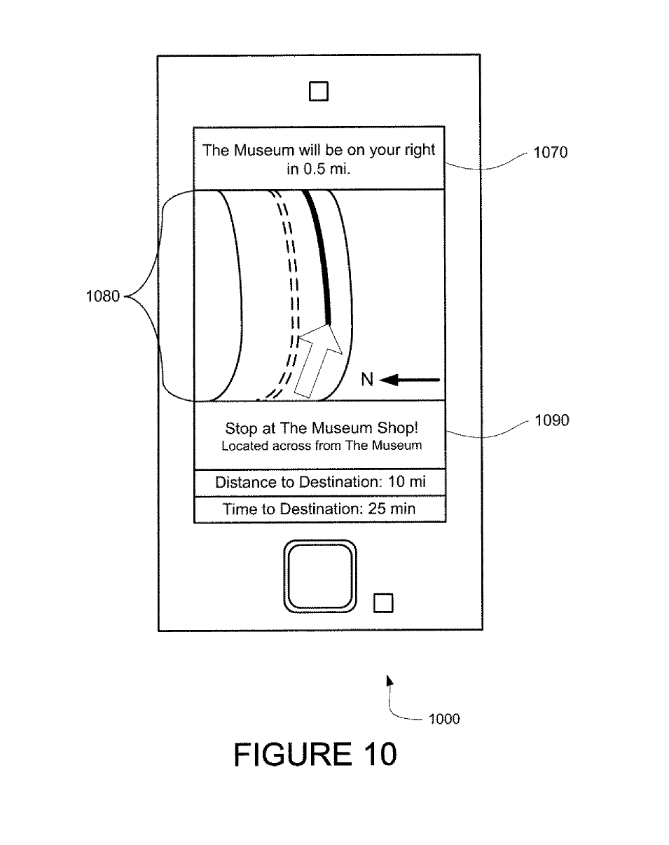

In another example, the server may transmit an advertisement associated with a particular POI while the client device is moving along the final touristic route. For example, the client device may be a mobile device, such as device 1000 of FIG. 10. In one example, the device may transmit, continuously or periodically, its current location to the server. Based on the current location of the client device, the server may identify and transmit an appropriate advertisement. Advertisement 1090, relating to the museum shop located proximate to the museum POI, may be displayed as the client device approaches the museum POI. In another example, the server may transmit the advertisement content to the client device with the final touristic route and an indication that the advertisement is to be displayed along with the route, as shown in FIG. 9, or when the client device reaches a particular location along the route, as shown in FIG. 10.

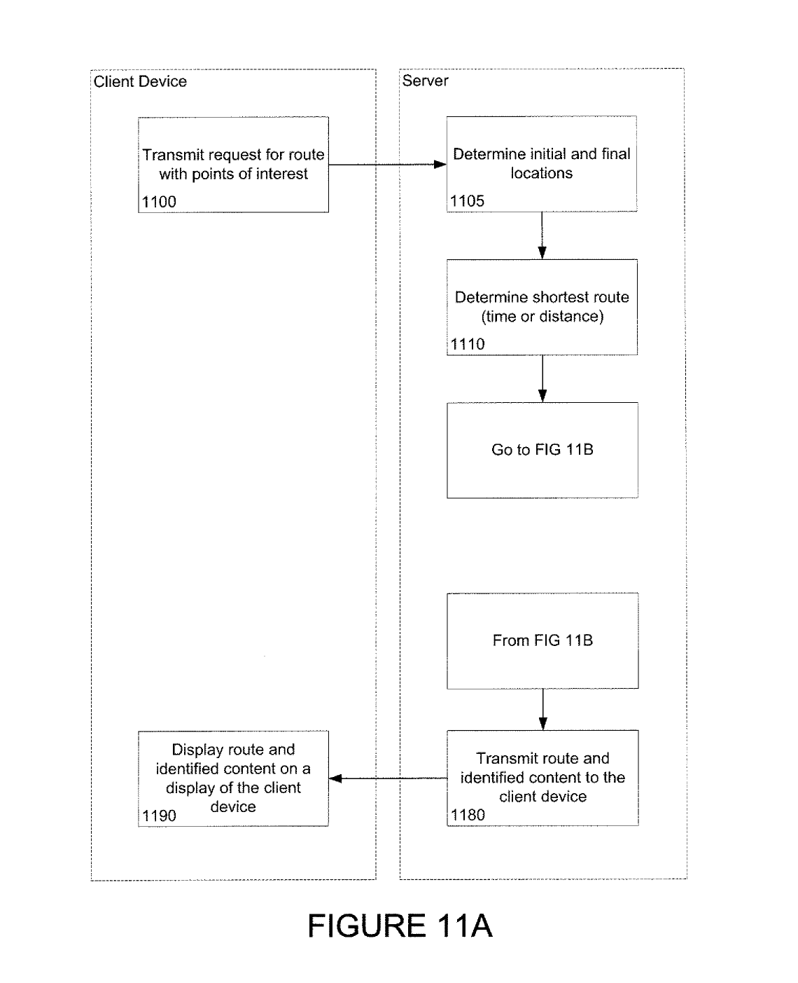

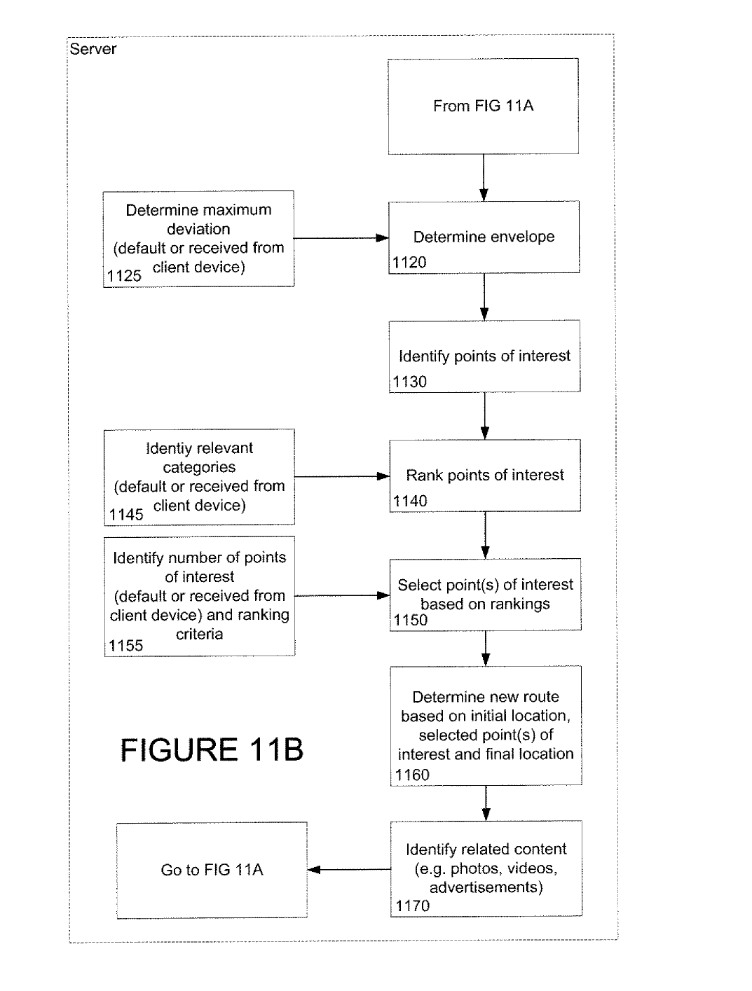

FIGS. 11A and 11B depict an exemplary summary of the processes described above. It will be understood that the following steps are merely exemplary, and thus may be performed in various different orders or simultaneously and may include additional steps not described below. Furthermore, the single server depicted in FIGS. 11A and 11B is merely exemplary and may comprise any number of servers performing one or more of these steps.

As shown in block 1100 of FIG. 11A, the client device transmits a request for a touristic route. The request may include a location set as described above. At block 1105, the server receives the location set and determines the initial and final locations, and if applicable, any intermediary locations. The server may use these locations to determine a shortest route between the locations of the location set at block 1110.

As shown in FIG. 11B, the server may use the route determined at block 1110 to determine an envelope as shown in block 1120. The envelope may be determined based on the maximum deviation value identified in block 1125. Next, at block 1130, the server may identify POIs located within the envelope. These identified POIs may be ranked and/or filtered at block 1140 based on the identified relevant categories and ranking criteria identified at block 1145. Next, the server may select POIs at block 1150 based on the rankings as well as the number of POIs to be selected identified at block 1155. Using the location set and the selected POIs, the server may determine a new route as shown in block 1160. The server may also identify content related to the POIs and/or route, including photos, videos, or advertisements as shown in block 1170. Returning to FIG. 11A, at block 1180, the server may transmit the new route and identified content to the client device for display at block 1190.

Where the user has identified a total time for the trip, the server may also provide the user with an estimation of how long the user should spend at each POI. The server may store and access default time periods for different category types, for example, a user may want to spend more time at a large museum than a small library. For example, returning to FIG. 7, the server has suggested a museum 1 and a library 2. If the user had identified a total trip time of 3 hours, the server may suggest that the user spend 1.75 hours at the museum and 50 minutes at the library. The server may also suggest an appropriate time to spend at a particular POI based on information contained in user reviews of the particular POI.

As described above, the user may define the locations, categories of POIs, as well as the characteristics of the envelope. Once the server has provided the final touristic route to the user by way of the client device, the server may also allow the user to select or disregard possible POIs. If a user selects a particular POI, the server may identify this POI as one in which this user, and possibly other users may be interested. Thus, the user may disregard one POI, and in response, the server may return a different final route less the disregarded POI or select a replacement POI. In another example, in addition to the POIs identified in the final touristic route, the server may identify or display a list of the next few highest ranked POIs so that the user may select additional POIs.

The above examples describe providing touristic routes for driving between locations, but the server may also, or instead, provide other types of touristic routes. For example, if the points are relatively close together, the server may suggest, or the user may request, a walking tour. Where the points are farther apart, the server may suggest single or multiple flight segments.

It will be further understood that the sample values, types and configurations of data described and shown in the figures are for illustration purposes only. In that regard, systems and methods in accordance with aspects of the invention may include different web sites, data values, data types and configurations, and may be provided and received at different times (e.g., via different web pages) and by different entities (e.g., some values may be pre-suggested or provided from different sources).

As these and other variations and combinations of the features discussed above can be utilized without departing from the invention as defined by the claims, the foregoing description of exemplary embodiments should be taken by way of illustration rather than by way of limitation of the invention as defined by the claims. It will also be understood that the provision of examples of the invention (as well as clauses phrased as “such as,” “e.g.”, “including” and the like) should not be interpreted as limiting the invention to the specific examples; rather, the examples are intended to illustrate only some of many possible aspects.

1. A method of providing a touristic route for display on a display apparatus of a client computer associated with a user, the method comprising:
receiving, from the client computer by one or more computing devices, a request for a touristic route including an initial destination and a final destination, the request further including a maximum amount of time for deviation to visit at least one point of interest;
determining, by the one or more computing devices, a shortest route between the initial destination and the final destination;
determining, by the one or more computing devices, based on the maximum amount of time for deviation, an envelope which describes a geographic area containing the shortest route;
accessing, by the one or more computing devices, a plurality of points of interest, each point of interest of the plurality being associated with a geographic location;
identifying, by the one or more computing devices, a first set of points of interest from the plurality of points of interest based on the geographic area of the envelope and the geographic location associated with each point of interest of the plurality;
ranking, by the one or more computing devices, the first set of points of interest based on ranking criterion;
identifying, by the one or more computing devices, a maximum number of points of interest to be selected;
selecting, by the one or more computing devices, points of interest from the first set of points of interest based on the maximum number of points of interest to be selected and the rankings of the first set of points of interest;
determining, by the one or more computing devices, a final touristic route between the initial destination and the final destination, the final touristic route including the selected points of interest;
identifying, by the one or more computing devices, advertisement content based on a characteristic of the final touristic path;
generating, by the one or more computing devices, a notification including the advertisement content for at least one of the selected points of interest; and
transmitting, by the one or more computing devices, to the client computer, the final touristic route and the notification for display to the user on the display apparatus.

2. The method of claim 1, wherein the initial destination and the final destination correspond to the same geographic location.

3. (canceled)

4. (cancelled)

5. (canceled)

6. The method of claim 1, wherein each point of interest of the plurality is associated with a category, and the request for a touristic location includes an identification of a category, the method further comprising filtering the first set of points of interest based on the identification of the category.

7. The method of claim 1, wherein the ranking criterion includes the average number of tourists visiting a point of interest yearly.

8. The method of claim 1, wherein the ranking criterion includes at least one user review of a given one of the plurality of points of interest.

9. The method of claim 1, further comprising identifying content associated with a particular selected point of interest and transmitting the identified content to the client computer.

10. The method of claim 9, wherein the identified content includes an advertisement.

11. The method of claim 9, wherein the identified content includes video.

12. The method of claim 9, wherein the identified content includes a hyperlink to a network location.

13. The method of claim 1, further comprising identifying content associated with the final touristic route and transmitting the identified content to the client computer.

14. The method of claim 1, wherein the maximum number of points of interest to be selected is identified in the request for a touristic route.

15. The method of claim 1, wherein the maximum number of points of interest is a default value accessible by the second computer.

16. (canceled)

17. A device for providing a touristic route for display on a display apparatus of a client computer associated with a user, the device comprising:
electronic memory accessible by the device; and
one or more processors programmed to:
receive, from the client computer, a request for a touristic route including an initial destination and a final destination, the request further including a maximum amount of time for deviation to visit at least one point of interest;
determine a shortest route between the locations of the location set;
determine, based on the maximum amount of time for deviation, an envelope which describes a geographic area proximate to the shortest route;
access a plurality of points of interest, each point of interest of the plurality being associated with a geographic location;
identify a first set of points of interest from the plurality of points of interest based on the geographic area of the envelope and the geographic location associated with each point of interest of the plurality;
rank the first set of points of interest based on ranking criterion;
identify a maximum number of points of interest to be selected;
select points of interest from the first set of points of interest based on the maximum number of points of interest and the rankings of the first set of points of interest;
determine, based on the maximum amount of time for deviation, a final touristic route between the initial destination and the final destination, the final touristic route including the selected points of interest;
identifying, by the one or more computing devices, advertisement content based on a characteristic of the final touristic path;
generating, by the one or more computing devices, a notification including the advertisement content for at least one of the selected points of interest; and
transmit, to the client computer, the final touristic route and the notification for display to the user on the display apparatus.

18. (canceled)

19. (cancelled)

20. The device of claim 17, wherein each point of interest of the plurality is associated with a category, and the request for a touristic location includes an identification of a category, the processor of the device further programmed to filter the first set of points of interest based on the identification of the category.

21. The device of claim 17, wherein the request for a touristic route also includes information to identify a category of route and wherein the processor is further programmed to determine the final touristic route based on the category of route.

22. The device of claim 17, wherein the category of route is a driving route.

23. A non-transitory, tangible computer-readable storage medium on which computer readable instructions of a program are stored, the instructions, when executed by a processor, cause the processor to perform a method of providing a touristic route for display on a display apparatus of a client computer associated with a user, the method comprising:
receiving, from a client computer, a request for a touristic route including an initial destination and a final destination, the request further including a maximum amount of time for deviation to visit at least one point of interest;
determining, by a second computer, a shortest route between the initial destination and the final destination;
determining, based on the maximum amount of time for deviation, an envelope which describes a geographic area containing the shortest route;
accessing a plurality of points of interest, each point of interest of the plurality being associated with a geographic location;
identifying a first set of points of interest from the plurality of points of interest based on the geographic area of the envelope and the geographic location associated with each point of interest of the plurality;
ranking the first set of points of interest based on ranking criterion;
identifying a maximum number of points of interest to be selected;
selecting points of interest from the first set of points of interest based on the maximum number of points of interest to be selected and the rankings of the first set of points of interest;
determining a final touristic route between the initial destination and the final destination, the final touristic route including the selected points of interest;
identifying, by the one or more computing devices, advertisement content based on a characteristic of the final touristic path;
generating, by the one or more computing devices, a notification including the advertisement content for at least one of the selected points of interest; and
transmitting, to the client computer, the final touristic route and the notification for display on the display apparatus.

24. The method claim 1, wherein the maximum amount of time is based on a percentage of a total time of the shortest route.

25. The method of claim 1, wherein the maximum amount of time is based on a total amount of additional time from a total time of the shortest route.

26. The method of claim 1, wherein the maximum amount of time is based on a total time for the final touristic route.

27. The method of claim 1, wherein the request for a touristic route further includes date and time information, the method further comprising, before selecting points of interest from the first set of points of interest, filtering the first set of points of interest to exclude points of interest having operating hours that do not correspond to the date and time information.

28. The method of claim 1, wherein the characteristic is a length of time for the final touristic route.
